(19) United States
(12) Patent Application Publication
(10) Pub. No.: US 2026/0037753 A1
(43) Pub. Date: Feb. 5, 2026

(54) COUPLING SPEECH ENCODERS WITH DOWNSTREAM TEXT MODELS

(71) Applicant: Google LLC, Mountain View, CA (US)

(72) Inventors: Ciprian Ioan Chelba, Palo Alto, CA (US); Johan Schalkwyk, Scarsdale, NY (US)

(73) Assignee: Google LLC, Mountain View, CA (US)

(21) Appl. No.: 19/274,236

(22) Filed: Jul. 18, 2025

Related U.S. Application Data
(60) Provisional application No. 63/678,218, filed on Aug. 1, 2024.

(51) Int. Cl. G06F 40/58; G06F 40/284; G06F 40/51; G10L 15/06; G10L 15/16

(52) U.S. Cl. CPC G06F 40/58; G06F 40/284; G06F 40/51; G10L 15/063; G10L 15/16

(57) ABSTRACT

A method includes receiving an exporter module training dataset including a plurality of transcribed speech utterances each spoken in a corresponding source language and including acoustic frames paired with a corresponding ground-truth transcription in the corresponding source language. For each transcribed speech utterance, the method also includes processing, using a pre-trained audio encoder, the acoustic frames to generate audio encodings; processing, using a speech decoder, the audio encodings to generate a 1-best sequence of predicted speech recognition labels in the source language; generating, using an exporter module, exporter embeddings by embedding the audio encodings aligned with the 1-best sequence of predicted speech recognition labels; and determining an L2 loss based the exporter embeddings and a sequence of source language embeddings. The method also includes training the exporter module based on the L2 losses determined for the transcribed speech utterances.

### CROSS-REFERENCE TO RELATED APPLICATIONS

This U.S. patent application claims priority under 35 U.S.C. § 119(e) to U.S. Provisional Application 63/678,218, filed on Aug. 1, 2024. The disclosure of this prior application is considered part of the disclosure of this application and is hereby incorporated by reference in its entirety.

### TECHNICAL FIELD

This disclosure relates to coupling speech encoders with downstream text models.

### BACKGROUND

Automatic speech translation (AST), the process of taking an audio input characterizing speech spoken in a first language and translating it into text in a second different language, is becoming an important technology. Conventionally, training AST models is typically plagued by a lack of parallel training data that includes speech and translated text pairs, which limits the ability to train AST models in an end-to-end fashion. Cascade models for AST, which include an automatic speech recognition (ASR) model in cascade with a downstream machine translation (MT) model have the advantage of leveraging large amounts of data used to build the ASR models and the MT models, respectively. The straightforward technique for building cascade AST models is to send the 1-best ASR transcription to the MT model for translation the 1-best ASR transcription into a different language. However, translating the ASR 1-best output has the obvious disadvantage that any further training/fine-tuning of the AST model on AST parallel data specific to a given domain is unable to back-propagate cross-entropy loss gradient through the interface between the cascaded ASR and MT models.

### SUMMARY

One aspect of the disclosure provides a computer-implemented method that when executed on data processing hardware causes the data processing hardware to perform operations that includes receiving training data including an exporter module training dataset that includes a plurality of transcribed speech utterances each spoken in a corresponding source language and including a corresponding sequence of acoustic frames paired with a corresponding ground-truth transcription in the corresponding source language of the transcribed speech utterance. For each transcribed speech utterance in the plurality of transcribed speech utterances of the exporter module training dataset, the operations also include: processing, using a pre-trained audio encoder of a speech recognition model, the corresponding sequence of acoustic frames to generate a corresponding sequence of audio encodings; processing, using a speech decoder of the speech recognition model, the corresponding sequence of audio encodings to generate a corresponding 1-best sequence of predicted speech recognition labels in the corresponding source language; generating, using an exporter module, a corresponding sequence of exporter embeddings by embedding the corresponding sequence of audio encodings aligned with the corresponding 1-best sequence of predicted speech recognition labels in the corresponding source language; and determining an L2 loss based the corresponding sequence of exporter embeddings and a sequence of source language embeddings. The sequence of source language embeddings is tokenized from the corresponding ground-truth transcription in the corresponding source language. The operations also include training the exporter module based on the L2 losses determined for the transcribed speech utterances while the speech recognition model remains fixed to teach the exporter module to learn how to generate sequences of exporter embeddings that match sequences of source language embeddings tokenized from corresponding ground-truth transcriptions.

Implementations of the disclosure may include one or more of the following optional features. In some implementations, the training data further includes an automated speech translation (AST) model training dataset for training a cascaded AST model that includes the speech recognition model, the exporter module, and a text model. The AST model training dataset includes a plurality of translated speech utterances each spoken in a corresponding source language and including a corresponding sequence of acoustic frames paired with a corresponding ground-truth translation of the translated speech utterance in a corresponding target language different than the corresponding source language. In these implementations, the operations further include, after training the exporter module, training the AST model on the AST model training dataset by: for each translated speech utterance in the plurality of translated speech utterances of the AST model training dataset: processing, using the pre-trained audio encoder of the speech recognition model, the corresponding sequence of acoustic frames to generate a corresponding sequence of audio encodings; processing, using the speech decoder of the speech recognition model, the corresponding sequence of audio encodings to generate a corresponding 1-best sequence of predicted speech recognition labels in the corresponding source language; generating, by the trained exporter module, a corresponding sequence of exporter embeddings by embedding the corresponding sequence of audio encodings aligned with the corresponding 1-best sequence of predicted speech recognition labels in the corresponding source language; processing, using a text model, the corresponding sequence of exporter embeddings to generate a corresponding sequence of predicted speech translation labels in the corresponding target language; and determining a translation loss term based on the corresponding sequence of predicted speech translation labels and the corresponding ground-truth translation; and updating parameters of the speech recognition model of the cascaded AST model by backpropagating the translation loss terms determined for the plurality of translated speech utterances. In these implementations, the text model may be immutable and/or may include a pre-trained large language model (LLM) having machine translation capabilities or a machine translation model including an encoder and a decoder.

In some examples, the operations further include: receiving an exporter module fine-tuning dataset including a plurality of translated speech utterances each spoken in a corresponding source language and including a corresponding sequence of acoustic frames paired with a corresponding ground-truth translation of the translated speech utterance in a corresponding target language different than the corresponding source language; and after training the exporter module based on the L2 losses determined for the transcribed speech utterances: for each translated speech utterance in the plurality of translated speech utterances of the exporter module fine-tuning dataset: processing, using the pre-trained audio encoder of the speech recognition model, the corresponding sequence of acoustic frames to generate a corresponding sequence of audio encodings; processing, using the speech decoder of the speech recognition model, the corresponding sequence of audio encodings to generate a corresponding 1-best sequence of predicted speech recognition labels in the corresponding source language; generating, by the trained exporter module, a corresponding sequence of exporter embeddings by embedding the corresponding sequence of audio encodings aligned with the corresponding 1-best sequence of predicted speech recognition labels in the corresponding source language; processing, using a text model, the corresponding sequence of exporter embeddings to generate a corresponding sequence of predicted speech translation labels in the corresponding target language; and determining a translation loss term based on the corresponding sequence of predicted speech translation labels and the corresponding ground-truth translation, and updating parameters of the exporter module based on the translation loss terms while parameters of the speech recognition model and the text model are held fixed.

In some implementations, the pretrained audio encoder of the speech recognition model is pretrained during an unsupervised training process by: receiving a corpus of un-transcribed speech utterances each not paired with a corresponding transcription; for each corresponding un-transcribed speech utterance in the corpus of un-transcribed speech utterances: generating, at each of a plurality of output steps, using a random-projection quantizer, a target quantized vector token and a target token index for a corresponding audio feature in a sequence of audio features associated with the corresponding un-transcribed speech utterance, wherein the target token index maps the corresponding audio feature to the target quantized vector token stored in one or more codebooks; after masking a subset of the audio features in the sequence of audio features associated with the corresponding un-transcribed speech utterance, generating, by the audio encoder, contrastive context vectors from corresponding masked audio features; and deriving a contrastive loss term between the contrastive context vectors at the masked positions and the target token index; and pretraining the audio encoder based on the contrastive loss terms determined for the plurality of un-transcribed speech utterances. In these implementations, after the unsupervised training process pretrains the audio encoder, the speech recognition model may be trained during a supervised training process by: receiving a corpus of transcribed speech utterances, each transcribed speech utterance paired with a corresponding transcription; at each of a plurality of output steps for each transcribed speech utterance; generating, using the speech decoder, a probability distribution over possible speech recognition hypotheses for the corresponding transcribed non-synthetic speech utterance; and determining a speech loss term based on the probability distribution over possible speech recognition hypotheses and the corresponding transcription paired with the transcribed speech utterance; and training the speech recognition model based on the speech loss terms. The speech decoder may include a CTC decoder and the speech loos term may include a CTC loss. Optionally, the speech decoder may include a recurrent neural network-transducer (RNN-T) decoder architecture and the speech loss term may include a RNN-T loss.

In some examples, the audio encoder includes a stack of self-attention layers each including a multi-headed self-attention mechanism. Here, the stack of self-attention layers may include a stack of conformer layers.

Another aspect of the disclosure provides a system that includes data processing hardware and memory hardware storing instructions that when executed on the data processing hardware causes the data processing hardware to perform operations that include receiving training data including an exporter module training dataset that includes a plurality of transcribed speech utterances each spoken in a corresponding source language and including a corresponding sequence of acoustic frames paired with a corresponding ground-truth transcription in the corresponding source language of the transcribed speech utterance. For each transcribed speech utterance in the plurality of transcribed speech utterances of the exporter module training dataset, the operations also include: processing, using a pre-trained audio encoder of a speech recognition model, the corresponding sequence of acoustic frames to generate a corresponding sequence of audio encodings; processing, using a speech decoder of the speech recognition model, the corresponding sequence of audio encodings to generate a corresponding 1-best sequence of predicted speech recognition labels in the corresponding source language, generating, using an exporter module, a corresponding sequence of exporter embeddings by embedding the corresponding sequence of audio encodings aligned with the corresponding 1-best sequence of predicted speech recognition labels in the corresponding source language, and determining an L2 loss based the corresponding sequence of exporter embeddings and a sequence of source language embeddings. The sequence of source language embeddings is tokenized from the corresponding ground-truth transcription in the corresponding source language. The operations also include training the exporter module based on the L2 losses determined for the transcribed speech utterances while the speech recognition model remains fixed to teach the exporter module to learn how to generate sequences of exporter embeddings that match sequences of source language embeddings tokenized from corresponding ground-truth transcriptions.

This aspect of the disclosure may include one or more of the following optional features. In some implementations, the training data further includes an automated speech translation (AST) model training dataset for training a cascaded AST model that includes the speech recognition model, the exporter module, and a text model. The AST model training dataset includes a plurality of translated speech utterances each spoken in a corresponding source language and including a corresponding sequence of acoustic frames paired with a corresponding ground-truth translation of the translated speech utterance in a corresponding target language different than the corresponding source language. In these implementations, the operations further include, after training the exporter module, training the AST model on the AST model training dataset by: for each translated speech utterance in the plurality of translated speech utterances of the AST model training dataset: processing, using the pre-trained audio encoder of the speech recognition model, the corresponding sequence of acoustic frames to generate a corresponding sequence of audio encodings; processing, using the speech decoder of the speech recognition model, the corresponding sequence of audio encodings to generate a corresponding 1-best sequence of predicted speech recognition labels in the corresponding source language; generating, by the trained exporter module, a corresponding sequence of exporter embeddings by embedding the corresponding sequence of audio encodings aligned with the corresponding 1-best sequence of predicted speech recognition labels in the corresponding source language; processing, using a text model, the corresponding sequence of exporter embeddings to generate a corresponding sequence of predicted speech translation labels in the corresponding target language; and determining a translation loss term based on the corresponding sequence of predicted speech translation labels and the corresponding ground-truth translation; and updating parameters of the speech recognition model of the cascaded AST model by backpropagating the translation loss terms determined for the plurality of translated speech utterances. In these implementations, the text model may be immutable and/or may include a pre-trained large language model (LLM) having machine translation capabilities or a machine translation model including an encoder and a decoder.

In some examples, the operations further include: receiving an exporter module fine-tuning dataset including a plurality of translated speech utterances each spoken in a corresponding source language and including a corresponding sequence of acoustic frames paired with a corresponding ground-truth translation of the translated speech utterance in a corresponding target language different than the corresponding source language; and after training the exporter module based on the L2 losses determined for the transcribed speech utterances: for each translated speech utterance in the plurality of translated speech utterances of the exporter module fine-tuning dataset: processing, using the pre-trained audio encoder of the speech recognition model, the corresponding sequence of acoustic frames to generate a corresponding sequence of audio encodings; processing, using the speech decoder of the speech recognition model, the corresponding sequence of audio encodings to generate a corresponding 1-best sequence of predicted speech recognition labels in the corresponding source language; generating, by the trained exporter module, a corresponding sequence of exporter embeddings by embedding the corresponding sequence of audio encodings aligned with the corresponding 1-best sequence of predicted speech recognition labels in the corresponding source language; processing, using a text model, the corresponding sequence of exporter embeddings to generate a corresponding sequence of predicted speech translation labels in the corresponding target language; and determining a translation loss term based on the corresponding sequence of predicted speech translation labels and the corresponding ground-truth translation; and updating parameters of the exporter module based on the translation loss terms while parameters of the speech recognition model and the text model are held fixed.

In some implementations, the pretrained audio encoder of the speech recognition model is pretrained during an unsupervised training process by: receiving a corpus of un-transcribed speech utterances each not paired with a corresponding transcription; for each corresponding un-transcribed speech utterance in the corpus of un-transcribed speech utterances: generating, at each of a plurality of output steps, using a random-projection quantizer, a target quantized vector token and a target token index for a corresponding audio feature in a sequence of audio features associated with the corresponding un-transcribed speech utterance, wherein the target token index maps the corresponding audio feature to the target quantized vector token stored in one or more codebooks, after masking a subset of the audio features in the sequence of audio features associated with the corresponding un-transcribed speech utterance, generating, by the audio encoder, contrastive context vectors from corresponding masked audio features; and deriving a contrastive loss term between the contrastive context vectors at the masked positions and the target token index; and pretraining the audio encoder based on the contrastive loss terms determined for the plurality of un-transcribed speech utterances. In these implementations, after the unsupervised training process pretrains the audio encoder, the speech recognition model may be trained during a supervised training process by: receiving a corpus of transcribed speech utterances, each transcribed speech utterance paired with a corresponding transcription; at each of a plurality of output steps for each transcribed speech utterance; generating, using the speech decoder, a probability distribution over possible speech recognition hypotheses for the corresponding transcribed non-synthetic speech utterance; and determining a speech loss term based on the probability distribution over possible speech recognition hypotheses and the corresponding transcription paired with the transcribed speech utterance; and training the speech recognition model based on the speech loss terms. The speech decoder may include a CTC decoder and the speech loos term may include a CTC loss. Optionally, the speech decoder may include a recurrent neural network-transducer (RNN-T) decoder architecture and the speech loss term may include a RNN-T loss.

In some examples, the audio encoder includes a stack of self-attention layers each including a multi-headed self-attention mechanism. Here, the stack of self-attention layers may include a stack of conformer layers.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example cascaded automatic speech translation (AST) model including an automated speech recognition (ASR) model, an exporter module, and a text model.

FIGS. 2A-2C are schematic views of example ASR model architectures that may be implemented by the cascaded AST model.

FIGS. 3A and 3B are schematic views of example ASR training processes for pre-training the ASR model of the cascaded AST model of FIG. 1.

FIGS. 4A-4C are schematic views of an example AST training process for training the cascaded AST model of FIG. 1.

FIG. 5 is a flowchart of an example arrangement of operations for a computer-implemented method of training the exporter module of the AST model of FIG. 1.

FIG. 6 is a schematic view of an example computing device that may be used to implement the systems and methods described herein.

Like reference symbols in the various drawings indicate like elements.

### DETAILED DESCRIPTION

Automated speech translation (AST), the process of taking an audio input characterizing speech spoken in a first language and translating it into text in a second different language, is becoming an important technology. Conventionally, training AST models is typically plagued by a lack of parallel training data that includes speech and translated text pairs, which limits the ability to train AST models in an end-to-end fashion. Cascade models for AST, which include an automatic speech recognition (ASR) model built in cascade with a downstream machine translation (MT) model have the advantage of leveraging large amounts of data used to build the ASR models and the MT models, respectively. The straightforward technique for building cascade AST models is to send the 1-best ASR transcription to the MT model for translation of the 1-best ASR transcription into a different language.

In addition to their modular architecture enabling the ability to leverage large amounts of available training data, another advantage cascade AST models is that the underlying architecture is in fact a multi-modal and multi-task one. For instance, the AST model may produce an ASR output, i.e., transcribed text of input speech, either in a stand-alone ASR mode or as a side-product of the AST task. Moreover, besides speech, the cascade AST model can accept a text input for translation. This multi-modal/task view on the AST task is firmly anchored in the reality of practical applications such that implementations herein are directed toward training/building an AST model that delivers both state of the art ASR and MT performance, while optimizing the AST performance within the constraints of multi-modal and multi-task constraints.

However, the technique of sending the 1-best ASR transcription to the downstream MT model when training cascade AST models has the obvious disadvantage that any further training/fine-tuning of the AST model on AST parallel data specific to a given domain is unable to back-propagate cross-entropy loss gradient through the interface between the cascaded ASR and MT models. For tighter coupling between the ASR and MT models, implementations herein are directed toward leveraging a 1-best ASR alignment that aligns the ASR encoder embeddings with the 1-best ASR sequence (e.g., ASR transcription) for input to the MT model, thereby resulting in a cascade architecture for AST that allows back-propagation gradient to flow from the MT model into components (i.e., audio encoder and speech decoder) of the ASR model. Specifically, implementations are directed toward integrating an exporter layer/module along the interface between the cascaded ASR and MT models that is trained under L2-loss to ensure a strong match between ASR embeddings and MT token embeddings for the 1-best ASR sequence. Here, the exporter module outputs exporter embeddings that are fed directly to the MT module in lieu of 1-best token embeddings, thereby resulting in a guarantee that the AST model performs no worse than the 1-best cascade baseline. In some examples, additional fine-tuning of the exporter module alone while keeping parameters of the ASR and MT models fixed satisfies the fundamental design constraint of building a cascade AST model that delivers both state of the ASR and MT performance. As will become apparent, the techniques disclosed herein for training the cascade AST model that integrates the exporter module offers a promising approach for coupling pre-trained audio encoders with immutable text models such as large language models (LLM) that can perform the MT task, i.e., text-to-text translation.

In some examples, the ASR model portion of the cascade AST model includes an audio encoder having a plurality of multi-head attention layers that is pre-trained on a large amount of un-transcribed speech utterances, thereby enabling the computation of 1-best labels and alignment using Connectionist Temporal Classification (CTC) techniques. The plurality of multi-head attention layers may include Conformer layers, Transformer layers, or other types of layers having multi-head attention mechanisms. In additional examples, the MT model portion of the cascade AST model includes a standard encoder-decoder architecture using cross attention between the decoder and the encoder and self-attention within either of the encoder or decoder (where self-attention in the decoder is causally masked). Thus, the encoder and decoder of the MT model may each include a plurality of multi-head attention layers such as Transformer layers, Conformer layers, or other types of layers having multi-head attention mechanisms. In some examples, the encoder-decoder architecture of the MT model uses rotary position embeddings.

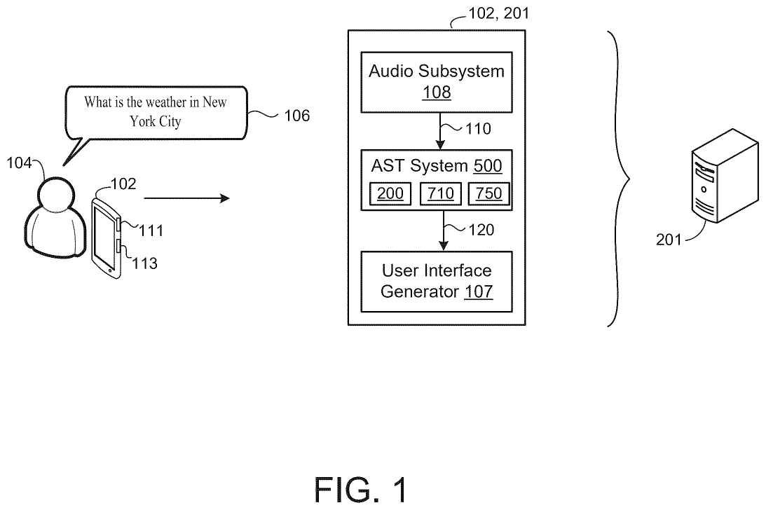

FIG. 1 illustrates a cascaded automated speech translation (AST) model 100 implementing an ASR model 200, an exporter module 710, and a text model 750 in cascade. The AST model 100 may reside on a user device 102 of a user 104 and/or on a remote computing device 201 (e.g., one or more servers of a distributed system executing in a cloud-computing environment) in communication with the user device 102. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the AST model 100. In the example shown, the user speaks a respective utterance 106 in a natural language of English for the phrase “What is the weather in New York City?” and the audio subsystem 108 converts the utterance 106 into corresponding acoustic frames 110 for input to the AST model 100. Thereafter, the AST model 100 receives, as input, the acoustic frames 110 corresponding to the utterance 106, and generates/predicts, as output, a corresponding translation 120 of the utterance 106 in a different language such as Spanish. The AST model 100 may have multi-task capabilities such that the ASR model 200 implemented by the ASt model 100 may output a corresponding transcription of the utterance 106 in the same language of English while the text model 750 may output the translation in the different language of Spanish.

In some configurations, the translation 120 and/or transcription output from the AST model 100 is processed, e.g., by a natural language understanding (NLU) module executing on the user device 102 or the remote computing device 201, to execute a user command. Additionally or alternatively, a text-to-speech system (e.g., executing on any combination of the user device 102 or the remote computing device 201) may convert the translation and/or transcription into synthesized speech for audible output by another device. For instance, the original utterance 106 may correspond to a message the user 104 is sending to a friend in which the translation 120 is converted to synthesized speech for audible output to the friend to listen to the message conveyed in the original utterance 106. The text model 750 may include a large language model configured to perform machine translation capabilities as well as NLU capabilities to provide a conversational interface with the user 104.

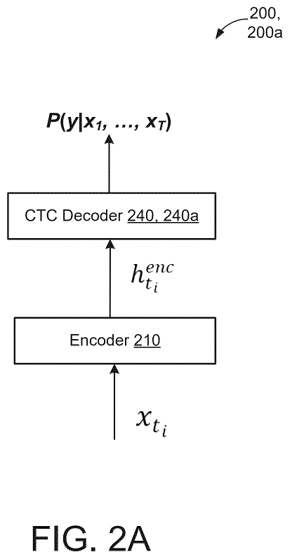

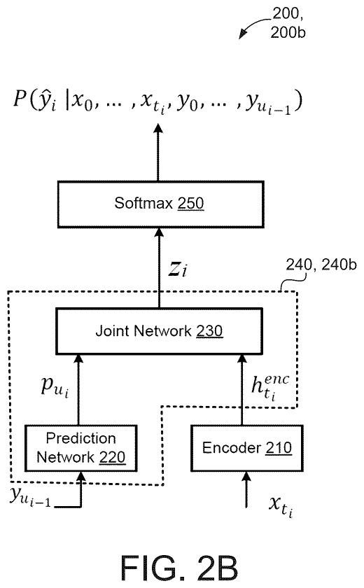

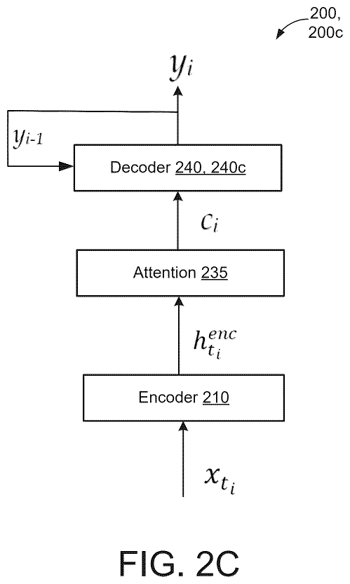

With reference to FIGS. 2A-2C, ASR model 200 may include an end-to-end (E2E) sequence-to-sequence model, such as a Connectionist Temporal Classification (CTC) model 200a (FIG. 2A), a Recurrent Neural Network-Transducer (RNN-T) model 200b (FIG. 2B), or an attention-based encoder-decoder (AED) model 200c (FIG. 2C). The CTC and RNN-T models 200a, 200b are specific types of frame alignment-based transducer models. The portion of the AST model 300 that includes the ASR model 200 may provide E2E speech recognition by integrating acoustic, pronunciation, and language models into a single neural network, and does not require a lexicon or separate text normalization component.

Referring to FIG. 2A, an example CTC model 200a includes an audio encoder network 210 and a CTC decoder 240, 240a. The audio encoder 210, which is roughly analogous to an acoustic model (AM) in a traditional ASR system, includes a stack of multi-head attention layers. The stack of multi-head attention layers may include Conformer layers, Transformer layers, or other types of layers that implement multi-head attention mechanisms. Optionally, the encoder 210 may include a recurrent network of stacked Long Short-Term Memory (LSTM) layers. The encoder reads a sequence of d-dimensional feature vectors (e.g., acoustic frames 110 (FIG. 1) x=(x₁, x₃, . . . , x_{T}), where xₜ∈ [symbol] _{d}, and produces at each time step a higher-order feature representation. This higher-order feature representation is denoted as

$${h}_{1}^{enc} , … , {h}_{T}^{enc} .$$

Similarly, the CTC decoder 240a performs a simple linear transformation followed by a Softmax normalization, such that the CTC decoder 240a projects all T steps of the higher-order feature representation 212 into a dimensionality of an output vocabulary. Here, the CTC decoder 240a makes a conditional independence assumption over characters in an output sequence. That is, at each time t, the CTC decoder 240a emits exactly one symbol, either a non-blank output label or a blank symbol. The output vocabulary for the sequence of non-blank output labels may include words, sub-word units (e.g., word pieces), graphemes, or phonemes. By contrast to the RNN-T model 200b implementing an RNN-T decoder 240, 240b discussed below, the cost of emitting the blank symbol by the CTC model 200a at each time step t is independent of previous emitted symbols.

FIG. 2B shows an example RNN-T model 200b which adheres to latency constrains associated with interactive applications. The RNN-T model 200b provides a small computational footprint and utilizes less memory requirements than conventional ASR architectures, making the RNN-T model architecture suitable for performing speech recognition entirely on the user device 102 (e.g., no communication with a remote server is required). The RNN-T model 200b includes an audio encoder 210 and a RNN-T decoder 240, 240b which includes a prediction network 220, and a joint network 230. The encoder 210, which is roughly analogous to an acoustic model (AM) in a traditional ASR system, includes a stack of multi-head attention layers. The stack of multi-head attention layers may include Conformer layers, Transformer layers, or other types of layers that implement multi-head attention mechanisms. Optionally, the encoder 210 may include a recurrent network of stacked Long Short-Term Memory (LSTM) layers. The encoder 210 reads a sequence of d-dimensional feature vectors (e.g., acoustic frames 110 (FIG. 1) x=(x₁, x₃, . . . , x_{T}), where xₜ∈ [symbol] _{d}, and produces at each output step a higher-order feature representation. This higher-order feature representation is denoted as

$${h}_{1}^{enc} , … , {h}_{T}^{enc} .$$

Similarly, the prediction network 220, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder 210 and prediction network 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 250) for determining the transcription 120.

The Softmax layer 250 may employ any technique to select the output label/symbol with the highest probability in the distribution as the next output symbol predicted by the RNN-T model 200b at the corresponding output step. In this manner, the RNN-T model 200b does not make a conditional independence assumption, rather the prediction of each symbol is conditioned not only on the acoustics but also on the sequence of labels output so far. The RNN-T model 200b does assume an output symbol is independent of future acoustic frames 110, which allows the RNN-T model to be employed in a streaming fashion.

In some examples, the audio encoder 210 of the RNN-T model 200b includes a stack of self-attention layers/blocks, such as conformer blocks. Here, each conformer block includes a series of multi-headed self-attention, depth wise convolution and feed-forward layers. The prediction network 220 may have two 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets.

Referring to FIG. 2C, an example AED model 200b associated with a Listen, Attend and Spell (LAS) model architecture that provides a single neural network including a listener audio encoder 210 which is analogous to a conventional acoustic model, an attender module 221 that acts as an alignment model, and a decoder 240, 240c that is analogous to the language model in a conventional system. Specifically, the listener audio encoder 210 takes the input features (e.g., acoustic frames 110 (FIG. 1)), x, and maps them to a higher-level feature representation, h^{enc}. This process of generating an encoded feature representation, h^{enc}, can be done for each of the multiple input frames, representing different input time steps. These timesteps are denoted with a subscript t below. Thus, for a set of frames {f₁, f₂, f₃ . . . fₜ} there can be a corresponding set of encoded outputs {h₁, h₂, h₃, . . . hₜ}.

The output of the listener audio encoder module 210 is passed to the attender module 221, which determines which encoder features in h^{enc} should be attended to in order to predict the next output symbol, yₜ, similar to a dynamic time warping (DTW) alignment module. In some examples, the attender module 221 is referred to herein as attender neural network or attender 221. The attender 221 can generate a context output cᵢ for each of multiple output steps i. For each context output vector cᵢ, the attender 221 can compute attention based on the encodings for one or more input steps t, e.g., the encoding for the current input step as well as encodings for previous input steps. For example, the attender 221 can generate an attention context output c; over the set of all the encoder outputs of the utterance, e.g., the entire set {h₁, h₂, h₃, . . . hₜ}. The attention context vector can be a vector representing a weighted summary of the current and previous encodings for frames (e.g., portions) of the utterance being recognized.

Finally, the output of the attender 221 is passed to the decoder 240c, which takes the attention context (e.g., a context vector or attention distribution), cᵢ, output by the attender 221, as well as an embedding of the previous prediction, yᵢ−1, to produce a decoder output. The decoder output can be a probability distribution, P (yᵢ|yᵢ₋₁, . . . y₀, x), over the current sub-word unit, yᵢ, given the previous units, {yᵢ₋₁, . . . , y₀}, and input, x. Accordingly, the decoder 240c generates, at each output step, a probability distribution over possible speech recognition hypotheses. As with the CTC model 200a and the RNN-T model 200b discussed above with reference to FIGS. 2A and 2C, the “possible speech recognition hypotheses” correspond to a set of output kabakas each representing a symbol/character/subword unit in a specified natural language.

Although not illustrated, the ASR model 200c may include a Softmax layer that receives output of the decoder 240c. In some implementations, the Softmax layer is separate from the decoder 240c and processes the output, yᵢ, from the decoder 240c, and the output of the Softmax layer is then used in a beam search process to select orthographic elements. In some implementations, the Softmax layer is integrated with the decoder 240c, so that the output yᵢ of the decoder 240c represents the output of the Softmax layer.

The decoder 240c and/or an associated softmax layer may be trained to output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols) or phonemes, but the set of output labels are not so limited. For example, the set of output labels can include sub-word units such as wordpieces and/or entire words, in addition to or instead of graphemes. The output distribution of the decoder 231 and/or the Softmax layer can include a posterior probability value for each of the different output labels. Thus, if there are 100 different output labels representing different graphemes or other symbols, the output yᵢ of the decoder or the output of a softmax layer that receives and processes the output yᵢ can include 100 different probability values, one for each output label. The probability distribution can then be used to select and assign scores to candidate orthographic elements (e.g., graphemes, wordpieces, and/or words) in a beam search process for determining the transcription.

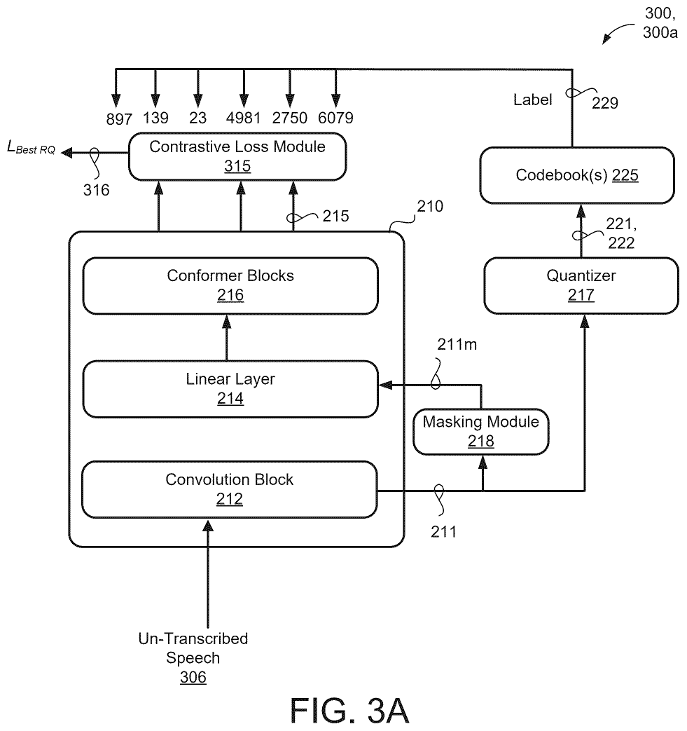

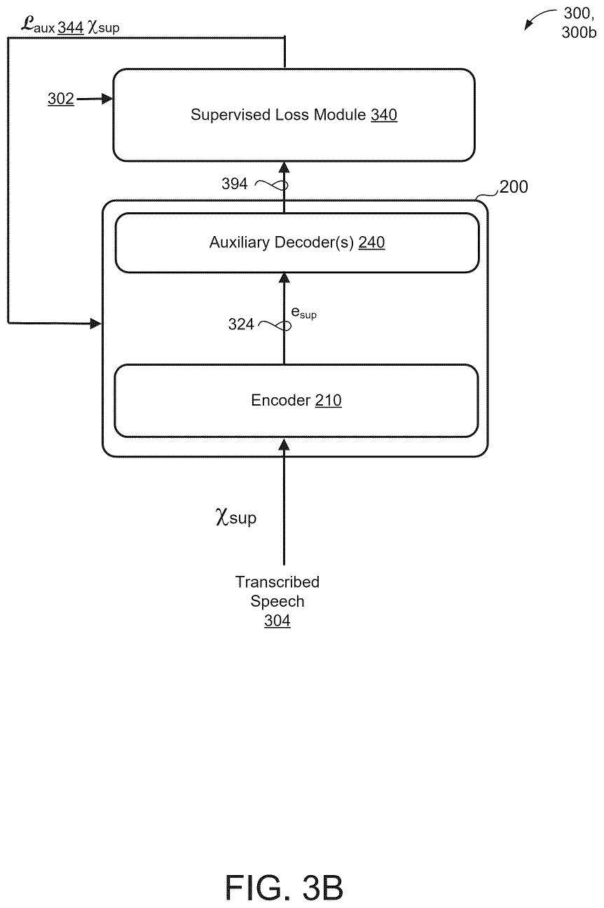

FIGS. 3A and 3B illustrate an example ASR training process 300 for training the ASR model 200 of the cascade AST model 400. For simplicity, the ASR training process 300 includes a contrastive self-supervised loss part 300a (FIG. 3A) and a supervised loss part 300b (FIG. 3B). The training process 300 pre-trains the audio encoder 210 based on contrastive losses (L_{Best RQ}) 316 derived using the contrastive self-supervised loss part 300a from a corpus of un-transcribed speech utterances (Xᵤₙₛᵤₚ) 306. Each un-transcribed speech utterance 306 includes audio-only data (i.e., unpaired data) such as that the un-transcribed speech utterance 306 is not paired with any corresponding transcription. Thereafter, the training process 300 trains the ASR model 200 based on supervised speech losses (Lₐᵤₓ) 344 derived using the supervised loss part 300b from a corpus of transcribed speech utterances (Xₛᵤₚ) 304. Each transcribed speech utterance 304 includes a corresponding transcription 302 paired with a corresponding speech representation of the corresponding transcribed speech utterance 304. In some examples, the un-transcribed speech utterances 306 and/or the transcribed speech utterances 304 are multilingual utterances.

Referring to FIG. 3A, in some implementations, the audio encoder 210 includes a Conformer encoder including a stack of conformer blocks each of which includes a series of multi-headed self attention, depth wise convolution, and feed-forward layers. Alternatively, the audio encoder 210 may include another type of encoder having a stack of self-attention layers/blocks, such as a transformer encoder. The Conformer encoder 210 can naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each un-transcribed speech utterance 306, and generates, as output, for each of a plurality of output steps, an encoded audio feature 211 that corresponds to a respective one of the un-transcribed speech utterances 306.

The encoded audio features 211 (i.e., interchangeably referred to as “encoded features 211”) output from the convolution subsampling block 212 may be fed to a masking module 218 where some of the encoded features 211 are randomly chosen and replaced with a trained feature vector shared between all masked time steps to provide corresponding masked encoded audio features 211m. In some examples, the masking module 218 masks the randomly chosen encoded features 211 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211 not chosen by the masking module 218) and outputs corresponding contrastive context vectors (i.e., encoded representation) 215 from masked encoded features 211m.

Moreover, a quantizer 217 receives the encoded features 211 as input, and applies random projections to generate, at each of the plurality of output steps, a target quantized vector token 221 and a target token index 222 for a corresponding encoded feature 211, 213 as output. As such, the quantizer 217 generates the target quantized vector token 221 and the target token index 222 using the encoded representations 211 that do not include any masking. Here, the quantizer 217 generates the target quantized vector tokens 221 according to

$${q}_{i} ∈ {\{ {e}_{j} \}}_{j = 1}^{V} .$$

The quantizer 217 summarizes all of the encoded features 211 into representative target quantized vector tokens (i.e., discriminative speech tokens) 221. The representative target quantized vector tokens 221 generated by the quantizer 217 represent a finite set of representative target quantized vector tokens referred to as a codebook 225. The target token index maps each corresponding encoded feature 211 to a respective one of the target quantized vector tokens 221 stored in the codebook 225. In some implementations, the quantizer 217 projects the target context vector 221 to a randomly initialized codebook 225 that maps the target context vectors 221 to discrete labels 229 by finding a nearest vector in the codebook 225. Notably, the quantizer 217 includes a random-projection quantizer 217 configured to randomly initialize a matrix and the codebook 225. The random-projection quantizer 217 uses the matrix to project the encoded features 211 into the target context vectors 221 and uses the codebook 225 to find a nearest vector where an index of the vector includes the label 229. In some examples, the codebook 225 finds the nearest vector by determining a cosine similarity as a distance measurement.

Thereafter, a contrastive loss module 315 derives a contrastive loss term (L_{BestRQ}) 316 between the contrastive context vectors 215 at the masked positions and the target context vectors 221 as follows.

$$L = - log \frac{exp ( sim ( {c}_{t} , {q}_{t} ) / k )}{{\sum }_{\tilde{q} ∼ {Q}_{t}} exp ( sim ( {c}_{t} , \tilde{q} ) / k )} \qquad ( 1 )$$

where cₜ is contrastive context vector 215 centered over a masked time step t and qₜ represents a target context vector 221 at the time step t in a set of K+1 candidate target context vectors 221 which includes qₜ and K distractors. Distractors may be uniformly sampled from other masked time steps of the same utterance. Advantageously, the contrastive loss 316 represents a Bidirectional Encoder Representations from Transformers (BERT)-based Speech pre-Training with Random Projection Quantizer (BEST-RQ) loss that does not require an additional quantization module that other contrastive losses (e.g., w2v-BERT) require. As such, since the BEST-RQ loss 316 does not require the additional quantization module, the BEST-RQ loss 316 enables the ASR model 200 to be more scalable for multiple languages during pre-training.

The contrastive loss (e.g., BEST-RQ loss) 316 is optimized between the contrastive context vectors 215 at the masked positions and the target context vectors 221. Accordingly, the semi-supervised part 300a of the training process 300a pre-trains the audio encoder 210 on the derived contrastive loss 316 applied on the corresponding encoded features 211 associated with each un-transcribed speech utterance 306 provided as input to the audio encoder 210. Pre-training the audio encoder 210 may include updating parameters of the audio encoder 210 based on the contrastive losses 316.

In some implementations, the contrastive self-supervised loss part 300a uses one or more codebooks 225 instead of using a single codebook 225. For example, the contrastive loss part 300a may use sixteen (16) codebooks 225. More specifically, the audio encoder 210 generates N number of contrastive context vectors 215 (e.g., probability predictions output from the audio encoder 210) using a corresponding N number of softmax output layers for each encoded feature 211. This is in contrast to generating a single contrastive context vector 215 for each encoded feature 211 using a single codebook 225. To that end, the contrastive self-supervised loss part 300a randomly initializes N number of different codebooks 225 and, using each respective codebook 225 of the N number of codebooks 225, to finds a respective nearest vector where an index of the vector includes the corresponding label 229 of the respective codebook 225. By using multiple codebooks 225, the contrastive self-supervised loss part 300a compares N number of contrastive context vectors 215 to a corresponding N number of labels 229 for each encoded feature 211. Advantageously, using multiple codebooks 225 enables the contrastive self-supervised loss part 300a to improve stability and convergence of the audio encoder 210 during training. In some examples, the contrastive self-supervised loss part 300a trains the audio encoder 210 using equal weights for each Softmax layer output of the audio encoder 210.

Referring to FIG. 3B, the supervised loss part 300b of the training process 300 is configured to update parameters of the ASR model 200 based on supervised speech loss terms 344 derived from the transcribed speech utterances 304. Notably, the supervised loss part 300b leverages one or more auxiliary decoders 240 for generating the supervised speech loss terms 344. The auxiliary decoders 240 may include Connectionist Temporal Classification (CTC) decoders 240a (FIG. 2A), RNN-T decoders 240b (FIG. 2B), or LAS decoders 240c (FIG. 2C). These auxiliary decoders 240 may include at least one of a phoneme decoder configured to decode a sequence of phonemes or a wordpiece decoder configured to decode a sequence of word pieces. The auxiliary decoders 240 could also include a grapheme decoder configured to decode a sequence of graphemes.

During the supervised loss part 300b, the audio encoder 210 is configured to receive transcribed speech utterances 304. That is, the audio encoder 210 generates encoded audio representations (eₛᵤₚ) 324 for speech inputs (i.e., transcribed speech utterances 304) at each corresponding time step. The auxiliary decoder 240 including the phoneme decoder or the wordpiece decoder receives, as input, each encoded audio representation 324 output from the audio encoder 210 and generates, as output, a probability distribution over possible speech recognition hypotheses 394 for the corresponding transcribed speech utterance 304 at the corresponding time step. In some examples, the second probability distribution over possible speech recognition hypotheses 394 includes the one of possible phoneme labels, the possible word piece labels, or the possible grapheme labels. Thereafter, a supervised loss module 340 may determine a speech loss term 344 based on the probability distribution over possible speech recognition hypotheses 394 and the corresponding transcription 302 paired with the transcribed non-synthetic speech utterance 304. Here, the corresponding transcription 302 serves as a ground-truth transcription and may include a sequence of target phonemes, target word pieces, and/or target graphemes. When the ASR model 200 includes the CTC model 200a that includes the CTC decoder 240a of FIG. 2A, the speech loss term 344 includes a CTC loss. When the ASR model 200 includes the RNN-T model 200b that includes the RNN-T decoder 240b of FIG. 2B, the speech loss term 344 includes an RNN-T loss.

The supervised loss part 300b may train the ASR model 200 on the supervised speech loss terms 344 by updating parameters of the audio encoder 210 and/or the decoder 240 using the supervised speech loss terms 344.

The transcribed speech utterances 304 corresponds to “paired” and “supervised” training data whereby the derived contrastive loss L_{BEST RQ} and the derived supervised loss [symbol] _{awx} associated with the supervised speech loss term 344 may be combined to obtain a paired data loss function, [symbol] _{paired}, as follows.

$${𝒥}_{paired} = {ℒ}_{BEST RQ} ( x \vert {θ}_{e} ) + {ℒ}_{aux} ( y \vert x , {θ}_{e} , {θ}_{d} ) \qquad ( 2 )$$

Implementations described above describe the ASR training process 300 used to train/pre-train a monolingual ASR model 200 or a multilingual ASR model 200. The resulting trained ASR model 200 may be integrated with the exporter module 710 and text model 750 to provide a cascade AST model 400 trained to perform the downstream task of speech translation. In some instances, the training process 300 may be employed to train end-to-end ASR models with decoder structures (i.e., non-pre-training) or fine-tune an ASR model to perform downstream tasks such as speech translation or natural language understanding. In some implementations, the audio encoder 210 performs chunk-wise attention on input utterances during training and inference.

The pre-trained audio encoder 210 of the ASR model 200 pre-trained by the contrastive self-supervised part 300a of the ASR training process 300a may include 24 multi-head attention layers (i.e., Conformer layers) having a dimension of 1,024, with a convolutional kernal of size five (5) for a total of 600 million parameters.

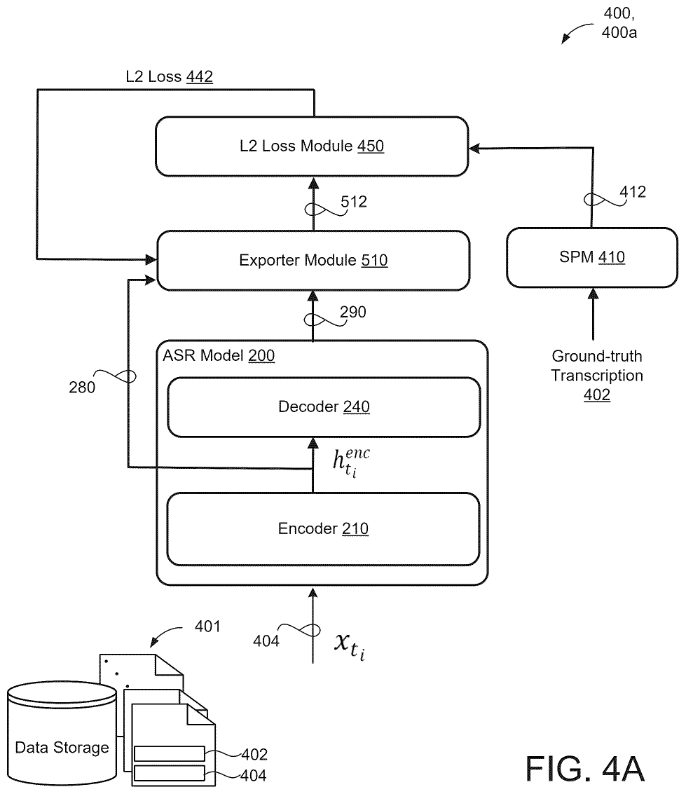

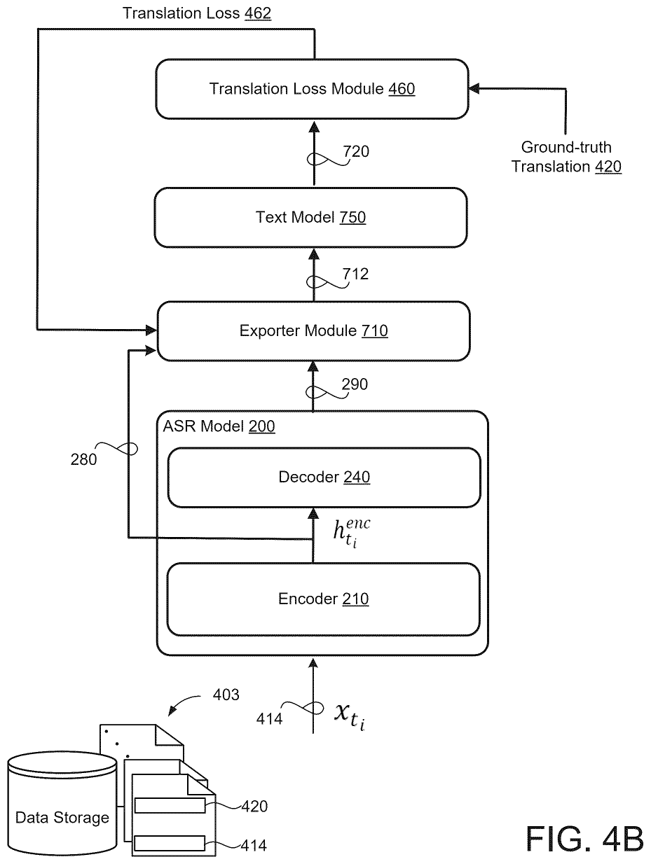

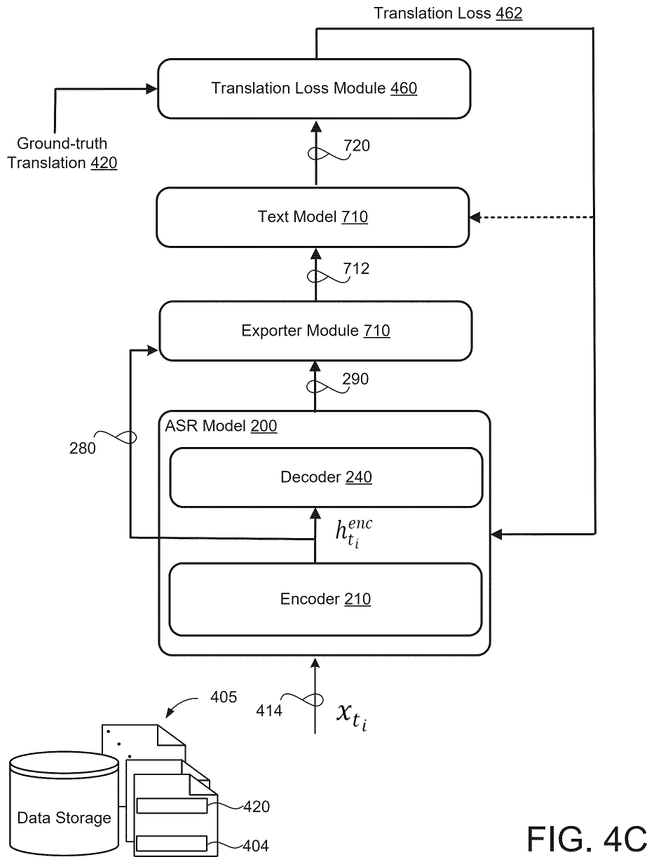

FIGS. 4A-4C depict an example AST training process for training the cascade AST model 100 that includes the ASR model 200 in cascade with a text model 750, whereby an exporter module 710 is disposed along the interface between the cascaded ASR and text models to ensure a strong match between ASR embeddings and MT token embeddings for a 1-best ASR output label sequence. The text model 750 may include a machine translation (MT) model 750 pre-trained to perform text translation by translating input text in a source language into output text in a target language different than the source language. The MT model may include an encoder-decoder architecture where the encoder and decoder each include a respective stack of multi-head attention layers. For instance, the MT model 750 may include 18 encoder layers and six (6) decoder layers of dimension 1,024, using 16 multi-head attention heads and rotary position embedding, resulting in the MT model 100 having about 300 million parameters. In some examples, the text model 750 is immutable such that the text model 750 is coupled in cascade with the ASR model 200 via the exporter module 710 and no further training/fine-tuning of the immutable text model 750 is performed. For instance, the text model 750 may include a pre-trained large language model (LLM) having a decoder-only architecture. By coupling the pre-trained ASR model 200 with the immutable text model 750 via the exporter module 710 to provide the cascade AST model 100, the cascade AST model 100 provides a robust multi-task speech recognition and text translation model without having to perform any additional incremental training of the immutable text model 750. As will become apparent, the training AST training process 400 may leverage various combinations of AST training data including input speech paired with corresponding transcriptions and/or translations. Examples herein depict the ASR model 200 as the CTC model 200a of FIG. 2A. In other examples, the ASR model 200 includes the RNN-T model 200b of FIG. 2B or the AED model 200c of FIG. 2C.

Referring to FIG. 4A, an L2 loss initialization portion 400a of the training process 400 initially trains the exporter module 710 to learn how to generate a sequence of exporter embeddings 712 derived from audio encodings 280 encoded by the audio encoder 210 that are aligned with a corresponding 1-best sequence of predicted speech recognition labels 290 output by the ASR model 200 such that the sequence of exporter embeddings 712 match a corresponding sequence of source language embeddings 412 tokenized from a corresponding ground-truth transcription 402 of an input speech utterance 404 spoken in a source language. The speech decoder 240 of the ASR model 200 may align the 1-best sequence of predicted speech recognition labels 290 with the audio encodings 280 encoded by the audio encoder 210. Notably, in the context of text translation, the ground-truth transcription 402 of the input speech utterance 404 correlates to input text in a source language that the text model 750 may translate into output text in a target language different than the source language. As such, the exporter module 710, once trained by the L2 initialization portion 400a of the AST training process 400, is configured to feed exporter embeddings 712 output by the exporter module 710 directly to the text model 750 in lieu of source language embeddings to preserve both state-of-the-art performance on both speech recognition and text translation tasks.

The L2 loss initialization portion 400a trains the exporter module 710 on training data that includes an exporter module training dataset 401 while parameters of the ASR model 200 are held fixed. In some examples, the exporter module 710 includes a plurality of multi-head attention layers. For instance, the exporter module 710 may include three (3) Conformer layers. The exporter module training dataset 401 includes a plurality of transcribed speech utterances 404 that each include a corresponding sequence of acoustic frames x₁, x₂, . . . xₜ characterizing the speech utterance spoken in a corresponding source language and paired with a corresponding ground-truth transcription 402 of the speech utterance in the corresponding source language. One or more of the transcribed speech utterances 404 may undergo data augmentation techniques to diversify the speech utterances 404. As such, data augmentation applied to one transcribed speech utterance 404 may produce multiple augmented speech utterances 404 each paired with the same corresponding ground-truth transcription 402.

For each transcribed speech utterance 404 in the plurality of transcribed speech utterances of the exporter module training dataset, the L2 loss initialization portion 400a of the AST training process processes, using the pretrained audio encoder 210 of the ASR model 200, the corresponding sequence of acoustic frames x₁, x₂, . . . xₜ characterizing the speech utterance 404 to generate a corresponding sequence of audio encodings (h₁, h₂, . . . , hₜ) 280, and processes, using the speech decoder 240 of the ASR model 200, the corresponding sequence of audio encodings to a generate a corresponding 1-best sequence of predicted speech recognition labels 290 in the corresponding source language. Here, the 1-best sequence of predicted speech recognition labels 290 corresponds to a transcription of the speech utterance 404 in the corresponding source language. The speech decoder 240 may include the CTC decoder that includes a single projection layer that generates frame-level posterior probabilities over an output vocabulary. The predicted speech recognition labels (or simply ‘logits’) may be, for example, sub-word units, such as wordpieces, phonemes, triphones, or graphemes. Thereafter, the L2 loss initialization portion 400a generates, using the exporter module 710, a corresponding sequence of exporter embeddings 710 and subsequently determines, via an L2 loss module 450, an L2 loss 442 based on the corresponding sequence of exporter embeddings 712 and the sequence of source language embeddings 412. Each exporter embedding 710 in the sequence is generated for a corresponding acoustic frame in the sequence of acoustic frames. Specifically, the exporter module 710 generates the corresponding sequence of exporter embeddings 712 by embedding the corresponding sequence of audio encodings 280 aligned with the corresponding 1-best sequence of predicted speech recognition labels 290 output from the ASR model 200. The sequence of source language embeddings 412 are tokenized by a sentence piece model (SPM) 412 from the corresponding ground-truth transcription 402 in the corresponding source language. The SPM 412 may be the same as the SPM used by the ASR model 200 to generate the 1-best sequence of predicted speech recognition labels 290 in the corresponding source language. The L2 losses 442 are used to update parameters of the exporter module 710 while parameters of the ASR model 200 are held fixed. The L2 losses 442 encourage the exporter module 710 to generate exporter embeddings 710 that match source language embeddings 412 derived from the ground-truth transcription 402.

In some examples, the speech decoder 240 of the ASR model 200 first aligns the corresponding sequence of audio encodings 280 with the corresponding 1-best sequence of predicted speech recognition labels 290. A reducer layer (not shown) may ensure that the dimensionality of the of the exporter embeddings 712 match the dimensionality of the source language embeddings 412 tokenized from the corresponding ground-truth transcription 402. The exporter module 710 may implement the reducer layer or the reducer layer may be a standalone layer that feeds the alignment information to the exporter module 710. The speech decoder 240 may feed the alignment information directly to the exporter module 710.

Referring to FIG. 4B, an optional exporter fine-tuning part 400b of the AST training process 400 fine-tunes the exporter module 710 after the L2 loss initialization portion 400a trains the exporter module 710. The exporter fine-tuning part 400b fine-tunes the exporter module 710 on an exporter module fine-tuning dataset 403 that includes a plurality of translated speech utterances 414 that each include a corresponding sequence of acoustic frames x₁, x₂, . . . xₜ characterizing the speech utterance spoken in a corresponding source language and paired with a corresponding ground-truth translation 420 of the speech utterance in a corresponding target language different than the corresponding source language. Notably, the exporter module training and fine-tuning datasets 401, 403 may be extracted from a shared AST training dataset that includes multiple training samples each including a speech utterance in a source language, a transcription of the speech utterance in the source language, and a translation of the speech utterance in a different target language. As such, one or more translated speech utterances 414 may overlap with transcribed speech utterances 404 used by the L2 loss initialization part such that the L2 loss initialization part 400a uses the paired ground-truth transcription 402 while the exporter fine-tuning part 400b instead uses the paired ground-truth translation 420. One or more of the translated speech utterances 414 may undergo data augmentation techniques to diversify the speech utterances 414. As such, data augmentation applied to one translated speech utterance 414 may produce multiple augmented speech utterances 414 each paired with the same corresponding ground-truth translation 420.

For each translated speech utterance 414 in the plurality of translated speech utterances of the exporter module fine-tuning dataset 403, the exporter fine-tuning part 400b of the AST training process processes, using the pretrained audio encoder 210 of the ASR model 200, the corresponding sequence of acoustic frames x₁, x₂, . . . xₜ characterizing the speech utterance 414 to generate a corresponding sequence of audio encodings (h₁, h₂, . . . , h₁) 280, and processes, using the speech decoder 240 of the ASR model 200, the corresponding sequence of audio encodings to a generate a corresponding 1-best sequence of predicted speech recognition labels 290 in the corresponding source language. Here, the 1-best sequence of predicted speech recognition labels 290 corresponds to a transcription of the speech utterance 404 in the corresponding source language. The speech decoder 240 may include the CTC decoder that includes a single projection layer that generates frame-level posterior probabilities over an output vocabulary. The predicted speech recognition labels (or simply ‘logits’) may be, for example, sub-word units, such as wordpieces, phonemes, triphones, or graphemes. Thereafter, the exporter fine-tuning part 400b generates, by the exporter module 710 trained via the L2 initialization part 400a, a corresponding sequence of exporter embeddings 712 by embedding the corresponding sequence of audio encodings 280 aligned with the corresponding 1-best sequence of predicted speech recognition labels 290 in the corresponding source language, and processes, using the text model 750, the corresponding sequence of exporter embeddings 712 to generate a corresponding sequence of predicted speech translation labels 720 in the corresponding target language. Here, the sequence of predicted speech translation labels 720 include text characterizing a predicted translation of the corresponding speech utterance in corresponding target language. The exporter fine-tuning part 400b includes a translation loss module 460 for determining a corresponding translation loss term 462 for each translated speech utterance 414 based on the corresponding sequence of predicted speech translation labels 720 and the corresponding ground-truth translation 420. Lastly, the exporter fine-tuning part 400b updates parameters of the exporter module 710 based on the translation loss terms 462 while parameters of the ASR model 200 and the text model 750 are held fixed.

Referring to FIG. 4C, an AST training part 400c of the AST training process 400 trains the cascaded AST model 100 after the L2 loss initialization portion 400a trains the exporter module 710, and (optionally) after the optional exporter module fine-tuning part 400b fine-tunes the exporter module 710. The AST training part 400c trains the cascaded AST model 100 on an AST model training dataset 405 that includes a plurality of translated speech utterances 414 that each include a corresponding sequence of acoustic frames x₁, x₂, . . . xₜ characterizing the speech utterance spoken in a corresponding source language and paired with a corresponding ground-truth translation 420 of the speech utterance in a corresponding target language different than the corresponding source language. Notably, the exporter module training dataset 401 and the AST model training dataset 405 may be extracted from a shared AST training dataset that includes multiple training samples each including a speech utterance in a source language, a transcription of the speech utterance in the source language, and a translation of the speech utterance in a different target language. As such, one or more translated speech utterances 414 may overlap with transcribed speech utterances 404 used by the L2 loss initialization part such that the L2 loss initialization part 400a uses the paired ground-truth transcription 402 while the AST training part 400c instead uses the paired ground-truth translation 420. One or more of the translated speech utterances 414 may undergo data augmentation techniques to diversify the speech utterances 414. As such, data augmentation applied to one translated speech utterance 414 may produce multiple augmented speech utterances 414 each paired with the same corresponding ground-truth translation 420.

For each translated speech utterance 414 in the plurality of translated speech utterances of the AST model training dataset 405, the AST training part 400c of the AST training process processes, using the pretrained audio encoder 210 of the ASR model 200, the corresponding sequence of acoustic frames x₁, x₂, . . . xₜ characterizing the speech utterance 414 to generate a corresponding sequence of audio encodings (h₁, h₂, . . . , h₁) 280, and processes, using the speech decoder 240 of the ASR model 200, the corresponding sequence of audio encodings to a generate a corresponding 1-best sequence of predicted speech recognition labels 290 in the corresponding source language. Here, the 1-best sequence of predicted speech recognition labels 290 corresponds to a transcription of the speech utterance 404 in the corresponding source language. The speech decoder 240 may include the CTC decoder that includes a single projection layer that generates frame-level posterior probabilities over an output vocabulary. The predicted speech recognition labels (or simply ‘logits’) may be, for example, sub-word units, such as wordpieces, phonemes, triphones, or graphemes. Thereafter, the AST training part 400c generates, by the exporter module 710 trained via the L2 initialization part 400a (and optionally fine-tuned via the exporter module fine-tuning part 400b), a corresponding sequence of exporter embeddings 712 by embedding the corresponding sequence of audio encodings 280 aligned with the corresponding 1-best sequence of predicted speech recognition labels 290 in the corresponding source language, and processes, using the text model 750, the corresponding sequence of exporter embeddings 712 to generate a corresponding sequence of predicted speech translation labels 720 in the corresponding target language. Here, the sequence of predicted speech translation labels 720 include text characterizing a predicted translation of the corresponding speech utterance in corresponding target language. The AST training part 400c includes a translation loss module 460 for determining a corresponding translation loss term 462 for each translated speech utterance 414 based on the corresponding sequence of predicted speech translation labels 720 and the corresponding ground-truth translation 420. Lastly, the AST training part 400b updates parameters of the ASR model 200 of the cascaded AST model 100 by backpropagating the translation loss terms 462 determined for the plurality of translated speech utterances 414 in the AST model training dataset 405. Here, the translation loss terms may correspond to cross-entropy loss gradients. Notably, the integration of the exporter module 710 trained to produce the exporter embeddings 712 permits the back-propagation gradient of the translation loss terms 462 to flow from the text model 750 model into the components of the ASR model 200. The training process 400 enables loose coupling of the pretrained ASR model and an immutable text model 750 via the trained exporter module 710 to provide the cascade AST model 100 that is capable of multi-task capabilities of speech recognition and speech translation. That is the cascade AST model 100 can perform both speech recognition tasks for transcribing speech utterances and speech translation tasks for translating speech utterances spoken in a source language into output text that translates the speech utterance in a target language different than the source language. In some configurations, the text model 750 is not immutable and permitted to be incrementally trained via backpropagation of the translation loss terms 462 through the text model 750.

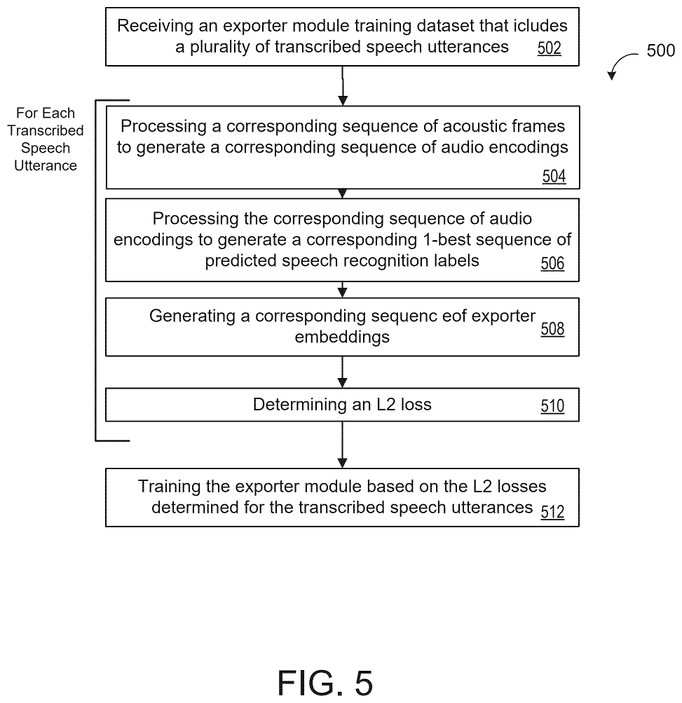

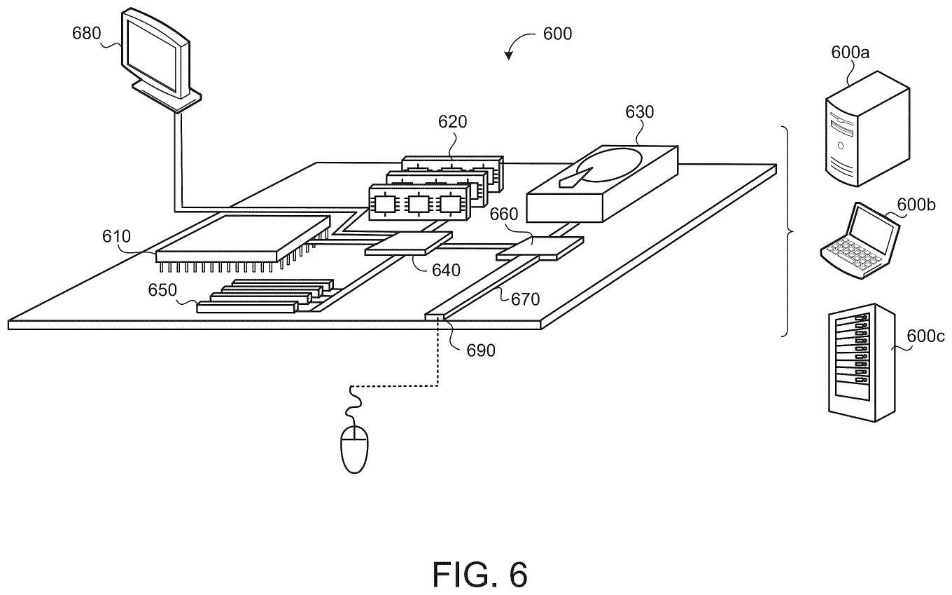

FIG. 5 is a flowchart of an example arrangement of operations for a computer-implemented method 500 of training a cascaded automated speech translation (AST) model 100. The method 500 may execute on data processing hardware 610 (FIG. 7) using instructions stored on memory hardware 620 (FIG. 7). The data processing hardware 610 and the memory hardware 620 may reside on the remote computer/server 201 and/or the user device 102 of FIG. 1 each corresponding to a computing device 600 (FIG. 6).

At operation 502, the method 500 includes receiving training data that includes an exporter module training dataset 401 that includes a plurality of transcribed speech utterances 404. Each transcribed speech utterance 404 is spoken in a corresponding source language and includes a corresponding sequence of acoustic frames paired with a corresponding ground-truth transcription 402 in the corresponding source language of the transcribed speech utterance 404.

For each transcribed speech utterance 404 in the plurality of speech utterances 404 of the exporter module training dataset 401, the method 500 performs operations 504-510. At operation 504, the method processes, using a pre-trained audio encoder 210 of a speech recognition model 200, the corresponding sequence of acoustic frames to generate a corresponding sequence of audio encodings 280, and at operation 506, the method 500 processes, using a speech decoder 240 of the speech recognition model 200, the corresponding sequence of audio encodings 280 to generate a corresponding 1-best sequence of predicted speech recognition labels 290 in the corresponding source language. At operation 508, the method 500 generates, using an exporter module 710, a corresponding sequence of exporter embeddings 712 by embedding the corresponding sequence of audio encodings 280 aligned with the corresponding 1-best sequence of predicted speech recognition labels 290 in the corresponding source language. At operation 510, the method 500 determines an L2 loss 442 based the corresponding sequence of exporter embeddings 712 and a sequence of source language embeddings 412. Here, the sequence of source language embeddings 412 are tokenized from the corresponding ground-truth transcription 402 in the corresponding source language. Notably, the SPM 410 that tokenizes the source language embeddings 412 from the transcription 402 may be the same as the SPM used by the ASR model 200 to tokenize the 1-best sequence of predicted speech recognition labels 290.

At operation 512, the method 500 trains the exporter module 710 based on the L2 losses 442 determined for the transcribed speech utterances 404 while the speech recognition model 200 remains fixed to teach the exporter module 710 to learn how to generate sequences of exporter embeddings 712 that match sequences of source language embeddings 412 tokenized from corresponding ground-truth transcriptions 402.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving training data comprising an exporter module training dataset, the exporter module training dataset comprising a plurality of transcribed speech utterances, each transcribed speech utterance spoken in a corresponding source language and comprising a corresponding sequence of acoustic frames paired with a corresponding ground-truth transcription in the corresponding source language of the transcribed speech utterance;
for each transcribed speech utterance in the plurality of transcribed speech utterances of the exporter module training dataset:
processing, using a pre-trained audio encoder of a speech recognition model, the corresponding sequence of acoustic frames to generate a corresponding sequence of audio encodings;
processing, using a speech decoder of the speech recognition model, the corresponding sequence of audio encodings to generate a corresponding 1-best sequence of predicted speech recognition labels in the corresponding source language;
generating, using an exporter module, a corresponding sequence of exporter embeddings by embedding the corresponding sequence of audio encodings aligned with the corresponding 1-best sequence of predicted speech recognition labels in the corresponding source language; and
determining an L2 loss based the corresponding sequence of exporter embeddings and a sequence of source language embeddings, the sequence of source language embeddings tokenized from the corresponding ground-truth transcription in the corresponding source language; and
training the exporter module based on the L2 losses determined for the transcribed speech utterances while the speech recognition model remains fixed to teach the exporter module to learn how to generate sequences of exporter embeddings that match sequences of source language embeddings tokenized from corresponding ground-truth transcriptions.

2. The computer-implemented method of claim 1, wherein:
the training data further comprises an automated speech translation (AST) model training dataset for training a cascaded AST model that comprises the speech recognition model, the exporter module, and a text model, the AST model training dataset comprising a plurality of translated speech utterances, each translated speech utterance spoken in a corresponding source language and comprising a corresponding sequence of acoustic frames paired with a corresponding ground-truth translation of the translated speech utterance in a corresponding target language different than the corresponding source language; and
the operations further comprise, after training the exporter module, training the AST model on the AST model training dataset by:
for each translated speech utterance in the plurality of translated speech utterances of the AST model training dataset:
processing, using the pre-trained audio encoder of the speech recognition model, the corresponding sequence of acoustic frames to generate a corresponding sequence of audio encodings;
processing, using the speech decoder of the speech recognition model, the corresponding sequence of audio encodings to generate a corresponding 1-best sequence of predicted speech recognition labels in the corresponding source language;
generating, by the trained exporter module, a corresponding sequence of exporter embeddings by embedding the corresponding sequence of audio encodings aligned with the corresponding 1-best sequence of predicted speech recognition labels in the corresponding source language;
processing, using a text model, the corresponding sequence of exporter embeddings to generate a corresponding sequence of predicted speech translation labels in the corresponding target language; and
determining a translation loss term based on the corresponding sequence of predicted speech translation labels and the corresponding ground-truth translation; and
updating parameters of the speech recognition model of the cascaded AST model by backpropagating the translation loss terms determined for the plurality of translated speech utterances.

3. The computer-implemented method of claim 2, wherein the text model is immutable.

4. The computer-implemented method of claim 2, wherein the text model comprises a machine translation model comprising an encoder and a decoder.

5. The computer-implemented method of claim 2, wherein the text model comprises a pre-trained large language model (LLM) having machine translation capabilities.

6. The computer-implemented method of claim 1, wherein the operations further comprise:
receiving an exporter module fine-tuning dataset comprising a plurality of translated speech utterances, each translated speech utterance spoken in a corresponding source language and comprising a corresponding sequence of acoustic frames paired with a corresponding ground-truth translation of the translated speech utterance in a corresponding target language different than the corresponding source language; and
after training the exporter module based on the L2 losses determined for the transcribed speech utterances:
for each translated speech utterance in the plurality of translated speech utterances of the exporter module fine-tuning dataset:
processing, using the pre-trained audio encoder of the speech recognition model, the corresponding sequence of acoustic frames to generate a corresponding sequence of audio encodings;
processing, using the speech decoder of the speech recognition model, the corresponding sequence of audio encodings to generate a corresponding 1-best sequence of predicted speech recognition labels in the corresponding source language;
generating, by the trained exporter module, a corresponding sequence of exporter embeddings by embedding the corresponding sequence of audio encodings aligned with the corresponding 1-best sequence of predicted speech recognition labels in the corresponding source language;
processing, using a text model, the corresponding sequence of exporter embeddings to generate a corresponding sequence of predicted speech translation labels in the corresponding target language; and
determining a translation loss term based on the corresponding sequence of predicted speech translation labels and the corresponding ground-truth translation; and
updating parameters of the exporter module based on the translation loss terms while parameters of the speech recognition model and the text model are held fixed.

7. The computer-implemented method of claim 1, wherein the pretrained audio encoder of the speech recognition model is pretrained during an unsupervised training process by:
receiving a corpus of un-transcribed speech utterances, each un-transcribed speech utterance not paired with a corresponding transcription;
for each corresponding un-transcribed speech utterance in the corpus of un-transcribed speech utterances:
generating, at each of a plurality of output steps, using a random-projection quantizer, a target quantized vector token and a target token index for a corresponding audio feature in a sequence of audio features associated with the corresponding un-transcribed speech utterance, wherein the target token index maps the corresponding audio feature to the target quantized vector token stored in one or more codebooks;
after masking a subset of the audio features in the sequence of audio features associated with the corresponding un-transcribed speech utterance, generating, by the audio encoder, contrastive context vectors from corresponding masked audio features; and
deriving a contrastive loss term between the contrastive context vectors at the masked positions and the target token index; and
pretraining the audio encoder based on the contrastive loss terms determined for the plurality of un-transcribed speech utterances.

8. The computer-implemented method of claim 7, wherein after the unsupervised training process pretrains the audio encoder, the speech recognition model is trained during a supervised training process by:
receiving a corpus of transcribed speech utterances, each transcribed speech utterance paired with a corresponding transcription;
at each of a plurality of output steps for each transcribed speech utterance:
generating, using the speech decoder, a probability distribution over possible speech recognition hypotheses for the corresponding transcribed non-synthetic speech utterance; and
determining a speech loss term based on the probability distribution over possible speech recognition hypotheses and the corresponding transcription paired with the transcribed speech utterance; and
training the speech recognition model based on the speech loss terms.

9. The computer-implemented method of claim 8, wherein:
the speech decoder comprises a CTC decoder; and
the speech loss term comprises a CTC loss.

10. The computer-implemented method of claim 8, wherein:
the speech decoder comprises a recurrent neural network-transducer (RNN-T) decoder architecture; and
the speech loss term comprises a RNN-T loss.

11. The computer-implemented method of claim 1, wherein the audio encoder comprises a stack of self-attention layers each including a multi-headed self-attention mechanism.

12. The computer-implemented method of claim 11, wherein the stack of self-attention layers comprises a stack of conformer layers.

13. A system comprising:
data processing hardware; and
memory hardware in communication with the data processing hardware, the memory hardware storing instructions that when executed on the data processing hardware cause the data processing hardware to perform any of the operations that include:
receiving training data comprising an exporter module training dataset, the exporter module training dataset comprising a plurality of transcribed speech utterances, each transcribed speech utterance spoken in a corresponding source language and comprising a corresponding sequence of acoustic frames paired with a corresponding ground-truth transcription in the corresponding source language of the transcribed speech utterance;
for each transcribed speech utterance in the plurality of transcribed speech utterances of the exporter module training dataset:
processing, using a pre-trained audio encoder of a speech recognition model, the corresponding sequence of acoustic frames to generate a corresponding sequence of audio encodings;
processing, using a speech decoder of the speech recognition model, the corresponding sequence of audio encodings to generate a corresponding 1-best sequence of predicted speech recognition labels in the corresponding source language;
generating, using an exporter module, a corresponding sequence of exporter embeddings by embedding the corresponding sequence of audio encodings aligned with the corresponding 1-best sequence of predicted speech recognition labels in the corresponding source language; and
determining an L2 loss based the corresponding sequence of exporter embeddings and a sequence of source language embeddings, the sequence of source language embeddings tokenized from the corresponding ground-truth transcription in the corresponding source language; and
training the exporter module based on the L2 losses determined for the transcribed speech utterances while the speech recognition model remains fixed to teach the exporter module to learn how to generate sequences of exporter embeddings that match sequences of source language embeddings tokenized from corresponding ground-truth transcriptions.

14. The system of claim 13, wherein:
the training data further comprises an automated speech translation (AST) model training dataset for training a cascaded AST model that comprises the speech recognition model, the exporter module, and a text model, the AST model training dataset comprising a plurality of translated speech utterances, each translated speech utterance spoken in a corresponding source language and comprising a corresponding sequence of acoustic frames paired with a corresponding ground-truth translation of the translated speech utterance in a corresponding target language different than the corresponding source language; and
the operations further comprise, after training the exporter module, training the AST model on the AST model training dataset by:
for each translated speech utterance in the plurality of translated speech utterances of the AST model training dataset:
processing, using the pre-trained audio encoder of the speech recognition model, the corresponding sequence of acoustic frames to generate a corresponding sequence of audio encodings;
processing, using the speech decoder of the speech recognition model, the corresponding sequence of audio encodings to generate a corresponding 1-best sequence of predicted speech recognition labels in the corresponding source language;
generating, by the trained exporter module, a corresponding sequence of exporter embeddings by embedding the corresponding sequence of audio encodings aligned with the corresponding 1-best sequence of predicted speech recognition labels in the corresponding source language;
processing, using a text model, the corresponding sequence of exporter embeddings to generate a corresponding sequence of predicted speech translation labels in the corresponding target language; and
determining a translation loss term based on the corresponding sequence of predicted speech translation labels and the corresponding ground-truth translation; and
updating parameters of the speech recognition model of the cascaded AST model by backpropagating the translation loss terms determined for the plurality of translated speech utterances.

15. The system of claim 14, wherein the text model is immutable.

16. The system of claim 14, wherein the text model comprises a machine translation model comprising an encoder and a decoder.

17. The system of claim 14, wherein the text model comprises a pre-trained large language model (LLM) having machine translation capabilities.

18. The system of claim 13, wherein the operations further comprise:
receiving an exporter module fine-tuning dataset comprising a plurality of translated speech utterances, each translated speech utterance spoken in a corresponding source language and comprising a corresponding sequence of acoustic frames paired with a corresponding ground-truth translation of the translated speech utterance in a corresponding target language different than the corresponding source language; and
after training the exporter module based on the L2 losses determined for the transcribed speech utterances:
for each translated speech utterance in the plurality of translated speech utterances of the exporter module fine-tuning dataset:
processing, using the pre-trained audio encoder of the speech recognition model, the corresponding sequence of acoustic frames to generate a corresponding sequence of audio encodings;
processing, using the speech decoder of the speech recognition model, the corresponding sequence of audio encodings to generate a corresponding 1-best sequence of predicted speech recognition labels in the corresponding source language;
generating, by the trained exporter module, a corresponding sequence of exporter embeddings by embedding the corresponding sequence of audio encodings aligned with the corresponding 1-best sequence of predicted speech recognition labels in the corresponding source language;
processing, using a text model, the corresponding sequence of exporter embeddings to generate a corresponding sequence of predicted speech translation labels in the corresponding target language; and
determining a translation loss term based on the corresponding sequence of predicted speech translation labels and the corresponding ground-truth translation; and
updating parameters of the exporter module based on the translation loss terms while parameters of the speech recognition model and the text model are held fixed.

19. The system of claim 13, wherein the pretrained audio encoder of the speech recognition model is pretrained during an unsupervised training process by:
receiving a corpus of un-transcribed speech utterances, each un-transcribed speech utterance not paired with a corresponding transcription;
for each corresponding un-transcribed speech utterance in the corpus of un-transcribed speech utterances:
generating, at each of a plurality of output steps, using a random-projection quantizer, a target quantized vector token and a target token index for a corresponding audio feature in a sequence of audio features associated with the corresponding un-transcribed speech utterance, wherein the target token index maps the corresponding audio feature to the target quantized vector token stored in one or more codebooks;
after masking a subset of the audio features in the sequence of audio features associated with the corresponding un-transcribed speech utterance, generating, by the audio encoder, contrastive context vectors from corresponding masked audio features; and
deriving a contrastive loss term between the contrastive context vectors at the masked positions and the target token index; and
pretraining the audio encoder based on the contrastive loss terms determined for the plurality of un-transcribed speech utterances.

20. The system of claim 19, wherein after the unsupervised training process pretrains the audio encoder, the speech recognition model is trained during a supervised training process by:
receiving a corpus of transcribed speech utterances, each transcribed speech utterance paired with a corresponding transcription;
at each of a plurality of output steps for each transcribed speech utterance:
generating, using the speech decoder, a probability distribution over possible speech recognition hypotheses for the corresponding transcribed non-synthetic speech utterance; and
determining a speech loss term based on the probability distribution over possible speech recognition hypotheses and the corresponding transcription paired with the transcribed speech utterance; and
training the speech recognition model based on the speech loss terms.

21. The system of claim 20, wherein:
the speech decoder comprises a CTC decoder; and
the speech loss term comprises a CTC loss.

22. The system of claim 20, wherein:
the speech decoder comprises a recurrent neural network-transducer (RNN-T) decoder architecture; and
the speech loss term comprises a RNN-T loss.

23. The system of claim 13, wherein the audio encoder comprises a stack of self-attention layers each including a multi-headed self-attention mechanism.

24. The system of claim 13, wherein the stack of self-attention layers comprises a stack of conformer layers.
